(19) United States
(12) Patent Application Publication
(10) Pub. No.: US 2012/0139940 A1
(43) Pub. Date: Jun. 7, 2012

(54) Video Overlay Techniques

(76) Inventor: Philippe Chavanne, Tucson, AZ (US)

(21) Appl. No.: 12/958,579

(22) Filed: Dec. 2, 2010

(51) Int. Cl. G09G 5/00

(52) U.S. Cl. 345/629

(57) ABSTRACT

Various technologies and techniques are disclosed for creating and displaying video overlays. A video playback system is described that includes a customizable video player that enables settings to be specified for a video overlay. The settings include a video to play as part of the video overlay as well as additional information to display as part of the video overlay. The video player enables the video overlay to be displayed on top of a web page when accessed by a visitor. Techniques for chaining video overlays together are also described. A first video overlay that includes a call to action is generated for display on top of a first web page. Based upon a response received for the call to action, a second video overlay is generated for display. A method for creating and displaying a customizable video overlay is also described.

### BACKGROUND

Videos are frequently used on web pages for a variety of reasons, such as for educational purposes, to promote a product or services, or for entertainment. Video sharing sites such as YouTube make it easy for anyone to post a video, and share it with others. Such video sharing sites also allow web site owners to embed videos within a particular web site, but where the videos are actually hosted on and streamed from one of the video sharing sites. When a video from a video sharing site is embedded onto another web site, you will generally see the logo of the video sharing site somewhere in the video or on the web page.

As the use of video has become more and more popular, it has become even more important for businesses to use video to help sell their products and services. The existing technology makes it pretty easy for business owners to record a basic video and upload it to a video sharing web site. However, business owners need the ability to create more advanced videos that have a more professional appearance and functionality.

Some business owners hire professional actors to record videos, and those videos can then be displayed on the web sites for the company. Such solutions tend to be expensive, as well as inflexible. If the business owner wants to make a change to the video, the actor has to be brought back into the studio to re-record the video or the modifications.

### SUMMARY

Various technologies and techniques are disclosed for creating and displaying video overlays. A video playback system is described that includes a customizable video player that enables settings to be specified for a video overlay. The settings include a video to play as part of the video overlay as well as additional information to display with the video as part of the video overlay. The customizable video player enables the video overlay to be displayed on top of a web page when the web page is accessed by at least one visitor.

In another implementation, techniques for chaining video overlays together are also described. A first video overlay is generated for display on top of a first web page, the first video overlay including a call to action. Based upon a response received from a visitor for the call to action, a second video overlay is generated for display, such as for display on top of the first web page, or on top of a second web page.

In another implementation, a method for creating and displaying a customizable video overlay is described. A selection is received of a video to use as part of a video overlay, as well as additional information to be displayed with the video. The video overlay is created from the video and the additional information. The video overlay is transmitted for display on top of the web page when the web page is accessed by at least one visitor.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a customizable video player of one implementation.

FIG. 2 is a high level diagrammatic view of a video playback system of one implementation.

FIG. 3 is a more detailed diagrammatic view of a video playback system of one implementation.

FIG. 4 is a process flow diagram for one implementation illustrating the stages involved in creating and playing video overlays with a customizable video player, and collecting usage data regarding the video overlays.

FIG. 5 is a diagrammatic view of a video overlay that can be customized with a variety of call to actions.

FIG. 6 is a simulated screen for one implementation that illustrates a video overlay with an opt-in box as a call to action.

FIG. 7 is a simulated screen for one implementation that illustrates a video overlay with a survey as a call to action, as well as a second overlay that contains a formatted list.

FIG. 8 is a simulated screen for one implementation that illustrates a video overlay with a split test as a call to action, as well as a second overlay that contains a formatted list.

FIG. 9 is a simulated screen for one implementation that illustrates a video overlay with a survey tag cloud, as well as a second overlay that contains a formatted list.

FIG. 10 is a simulated screen for one implementation that illustrates a video overlay with an advertisement.

FIG. 11 is a simulated screen for one implementation that illustrates a video overlay with an advertisement that is to an advertising network offer.

FIG. 12 is a diagrammatic view that illustrates using a customizable video player to deliver local content and local advertising.

FIG. 13 is a diagrammatic view that illustrates some examples of what can be delivered for local content and local advertising with the customizable video player, as well as possible interactions between the local content and the ad server.

FIG. 14 is a simulated screen for one implementation that illustrates repositioning the video overlay that is displayed using the customizable video player.

FIG. 15 is a process flow diagram for one implementation that illustrates creating and displaying a customizable video overlay.

FIG. 16 is a simulated screen for one implementation that illustrates some exemplary options available for creating a video overlay, and in selecting a video to use in a video overlay.

FIG. 17 is a simulated screen for one implementation that illustrates viewing and modifying video overlays.

FIG. 18 is a simulated screen for one implementation that illustrates confirming a video that has been selected for use in a video overlay.

FIG. 19 is a simulated screen for one implementation that illustrates selecting one or more web pages to display the video overlay on top of.

FIG. 20 is a simulated screen for one implementation that illustrates selecting dimensions to be used for the video overlay.

FIG. 21 is a simulated screen for one implementation that illustrates adding closed caption information to be displayed with the video in the video overlay.

FIG. 22 is a simulated screen for one implementation that illustrates adding a formatted list to be displayed in the video overlay.

FIG. 23 is a simulated screen for one implementation that illustrates customizing the position and other details for a formatted list to be displayed in the video overlay.

FIG. 24 is a simulated screen for one implementation that illustrates creating a call to action for the video overlay.

FIG. 25 is a simulated screen for one implementation that illustrates selecting display positions for the video overlay.

FIG. 26 is a simulated screen for one implementation that illustrates selecting the preview options that will allow the video overlay to be previewed on the web page.

FIG. 27 is a simulated screen for one implementation that illustrates previewing the video overlay on the top of the web page to see how it looks.

FIG. 28 is a diagrammatic view of a computer system of one implementation.

### DETAILED DESCRIPTION

The technologies and techniques herein may be described in the general context as a customizable video player application, but the technologies and techniques also serve other purposes in addition to these. In one implementation, one or more of the techniques described herein can be implemented as features within a web site creation system, a web site content management system, or from any other type of program or service that creates, manages, or delivers web pages. In another implementation, one or more of the techniques described herein are implemented as features with other applications that create or playback videos.

A customizable video player is described that allows a web site owner or other authorized user to create and customize video overlays that are displayed on one or more web pages on a web site. The term “video overlay” as used herein is meant to include a video that is played on top of a web page, along with additional content for the video overlay, if any were specified. The web site owner or other user can edit the video overlay settings and content to customize the appearance and content of the video overlay.

A few non-limiting examples of additional content that can be specified for the video overlay include closed captions, one or more formatted lists, and one or more calls to action. This additional content can be displayed in the video overlay with all or part of the video. The term “closed caption” as used herein is meant to include a textual description that provides additional information about what is being displayed on the video at a particular point in time. The term “formatted list” as used herein is meant to include an area that is displayed as part of the video overlay that includes additional text and/or graphical information to make additional points or comments about the video. The term “call to action” as used herein is meant to include a specific action that is being requested from the visitor, such as entering a name and email, selecting a preferred option, completing a survey, etc.

Other settings can also be specified for the video overlay, such as the dimensions of the video overlay, the position(s) that it should be displayed on the screen, and so on. Multiple positions can be specified so that the video overlay can be used to demonstrate multiple parts of the web page to the visitor and/or to draw the visitor's attention to different parts of the web page.

Detailed sub-id information can be tracked about how visitors reach a web page. The term “sub-id” as used herein is meant to include one or more details about how a visitor arrived on the web site and certain details about what the visitor does (how the visitor behaves) on pages of the web site. The sub-id information can then be used to further customize the video overlay. For example, if a visitor reaches a particular web page based upon a key word of “computer monitor”, then the video overlay that is displayed on the web page can be customized in a way that is specific to computer monitors. Video overlays can also be chained together, where the response that is given to one call to action in a video overlay can cause another video overlay to be displayed on the same or a different web page.

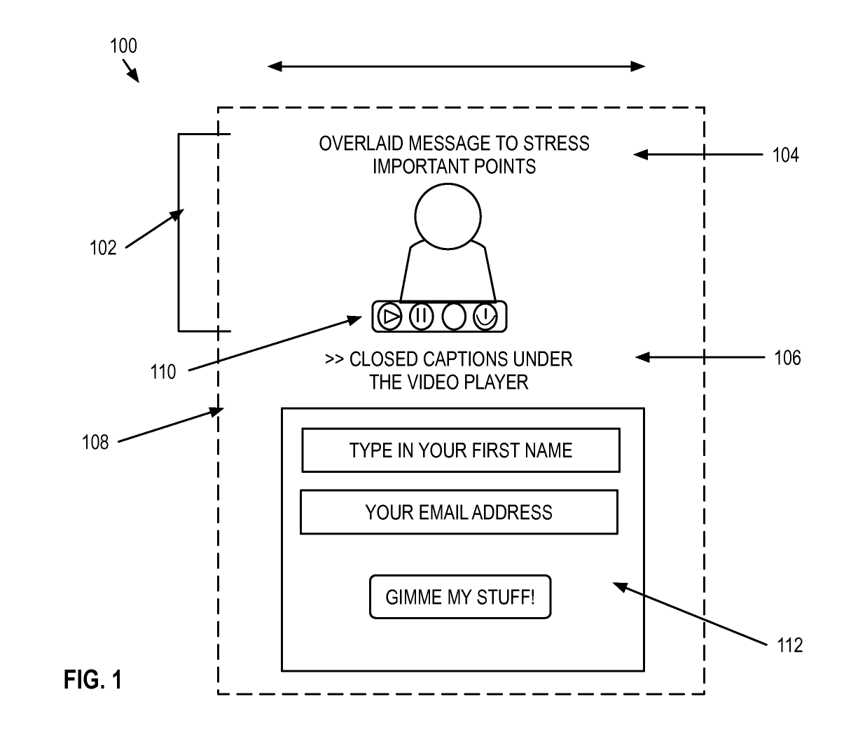

FIG. 1 is a diagrammatic view of a customizable video overlay 100 of one implementation. Video overlay 100 is displayed on top of a web page when visitors access the web page. Video overlay 100 has various components that can be customized. Stage 102 is where the video plays. In one implementation, users can customize the type and color of the background for stage 102, such as to set it to a transparent background, or a colored background. In one implementation, formatted list 104 can be displayed to convey certain topics or points of information. Formatted list 104 can be styled in a variety of ways, such as with bulleted text, with graphics, with a combination of video and graphics, with a colored background, with a transparent background, etc. Closed captions 106 can be displayed for the video to provide textual information about what is being displayed in the video. Frame 108 surrounds the video overlay 100. In some implementations, frame 108 is transparent. In other implementations, frame 108 can have a visible border.

Video player controls 110 can be used to control the playback of video overlay 100, such as to play, pause, advance and rewind video overlay 100. A call to action 112 can also be displayed as part of the video overlay 100. In the example shown in FIG. 1, the call to action 112 is an opt-in box that prompts the user to enter a first name and an email address. Various other types of calls to action could be used in other implementations, such as surveys, split tests, advertisements, as are described in further detail in later figures. While the video overlay can be customized to include some or all of these additional features (closed caption, formatted list, call to action, etc.), in some implementations, the video overlay may simply play a video on top of a web page without using these additional features.

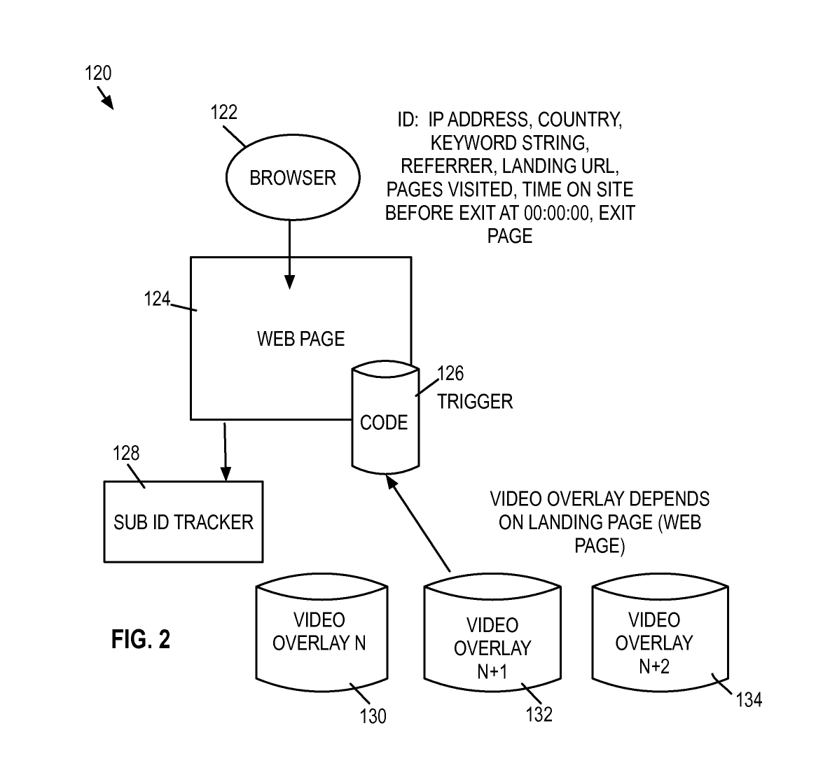

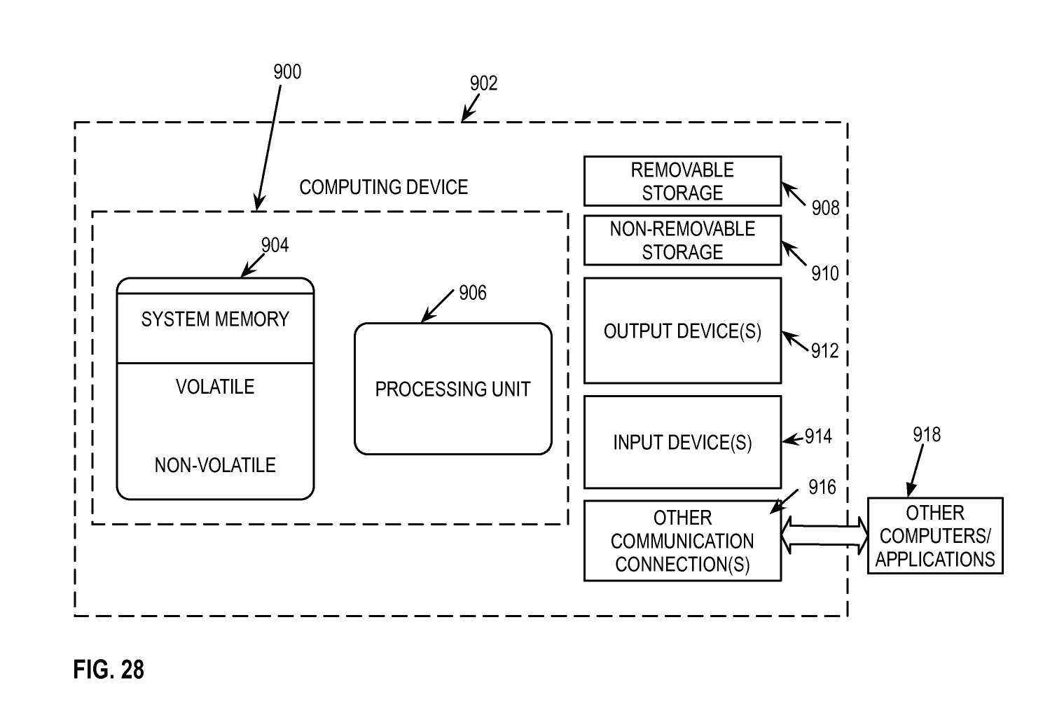

Turning now to FIGS. 2-27, the stages for implementing one or more implementations of a customizable video player that manages video overlays are described in further detail. In some implementations, the processes of FIG. 2-27 are at least partially implemented in the operating logic of one or more computing devices 900 (of FIG. 28).

FIG. 2 is a high level diagrammatic view of a video playback system 120 of one implementation. When a visitor accesses a particular web page 124 of a web site using a web browser 122, a piece of embed code 126 that is embedded into the web page 124 triggers a video overlay (such as 130, 132, or 134) to be displayed. The video overlay that is displayed (such as 130) can depend on the particular web page 124 that has been visited on the web site, as well as other criteria and/or settings.

Embed code 126 can also trigger a sub-id tracker 128 to start tracking details regarding how the visitor reached the web page 124 and/or what the visitor does while on the web site. A few non-limiting examples of the type of information that sub-id tracker 128 can gather include an IP address of the visitor's computer, the country of the visitor, key word string, referring site, landing page URL, pages visited, time on the site before existing, the exit page when the visitor leaves the web site, and so on.

In one implementation, video overlay 130 is customized based upon information gathered by the sub-id tracker 128. As one non-limiting example, if sub-id tracker 128 determined that a particular key word was entered into a search engine to locate the web page 124, then the video overlay can include certain video content or text that is specific to that key word.

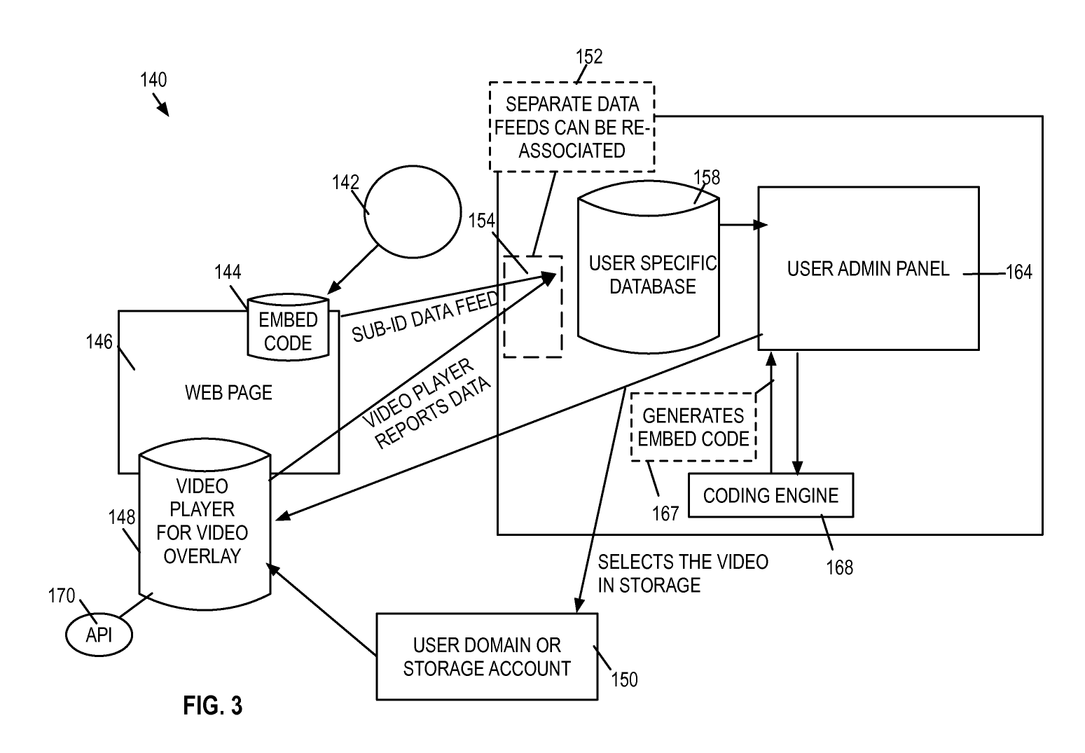

FIG. 3 is a more detailed diagrammatic view of a video playback system 140 of one implementation. Customizable video player 148 enables customized settings to be specified for a video overlay. The customized settings are stored in a user specific database 158. The customized settings can include a video to play as part of the video overlay as well as additional information to display with the video as part of the video overlay. Customizable video player 148 enables the video overlay to be displayed on top of a web page 146 when web page 146 is accessed by at least one visitor using a web browser 142.

When a visitor accesses web page 146 using web browser 142, a piece of code 144 that is embedded into web page 146 triggers the sub-id tracker to start collecting data about how the visitor reached the web site, and/or what the visitor does while on the web site. The sub-id information is transmitted as part of a sub-id data feed 154.

Code 144 that is embedded into web page 146 also triggers customizable video player 148 to start playing the video overlay on top of web page 146. In one implementation, customizable video player communicates with user admin panel 164 to create the video overlay. The video overlay is created by retrieving the video and/or other additional information about the video overlay from the user specific database 158, user domain or storage account 150, and/or other data store(s). It will be appreciated that the data for the video overlay, including the video itself, and the additional information regarding the customization settings could be located in various formats or data stores, as long as they are accessible by customizable video player 148. In one implementation, customizable video player 148 also reports sub-id data to the sub-id data feed 154, such as details about how the visitor responded to a particular call to action. Separate data feeds 152 can be re-associated, such as to associate data for the same visitor that was collected from different data feeds.

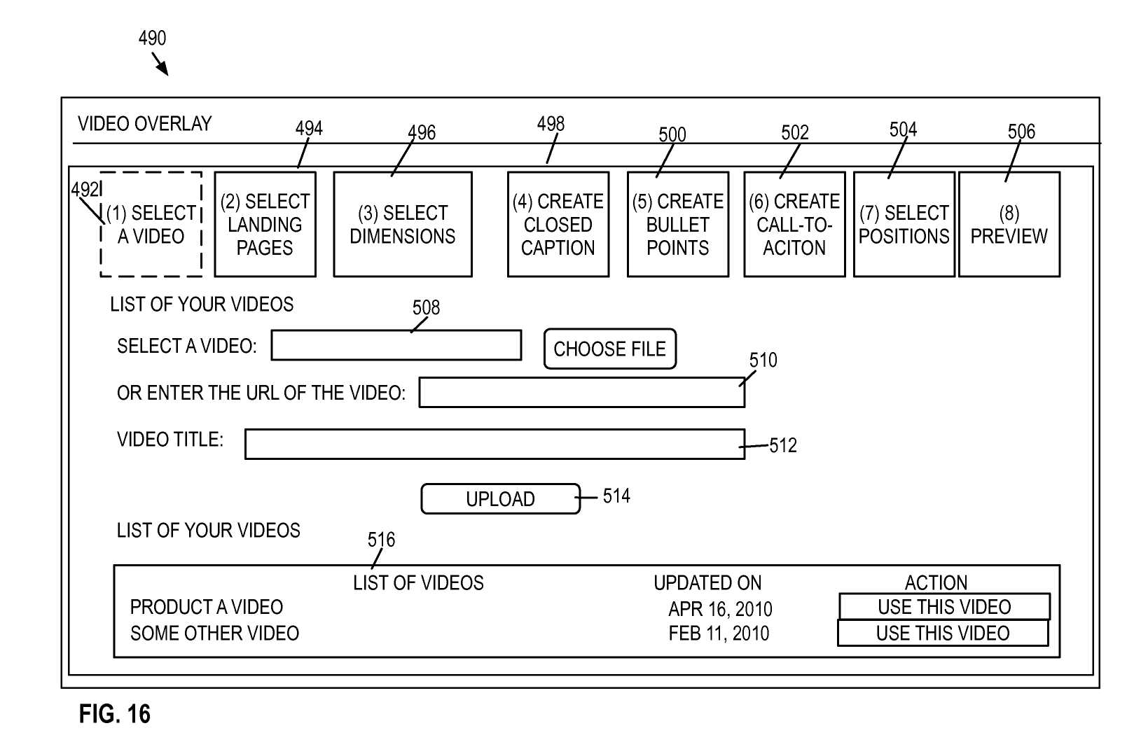

An administrator for the web site or another authorized user can customize how the video overlay will be displayed. These customizations are made using user admin panel 164. Several example screens of how user admin panel 164 can be used to create and customize video overlays are shown in FIGS. 16-27. User admin panel stores the various customizations for the video overlay in user specific database 158, user domain or storage account 150, and/or another data store(s). Once the administrator is ready to activate a particular video overlay on one or more web pages on the web site, coding engine 168 generates the code 167 that can be embedded on the web pages that the video overlay should be displayed with (i.e. embed code 144). Embed code 144 is then placed inside the selected web page(s) so that it will later trigger the customizable video player 148 to play the video overlay on the web page 146.

In another implementation, video playback system 140 can be delivered to end users of system 140 with through an application programming interface 170, such as using an API key. Such an implementation allows the end user of the system to associate the system with more powerful databases, and/or to collect data over a plurality of servers. This implementation is useful for numerous other purposes as well, such as if the end user of the system wishes to integrate the functionality of video playback system 140 with its own custom programs that have already been developed, or that are being developed.

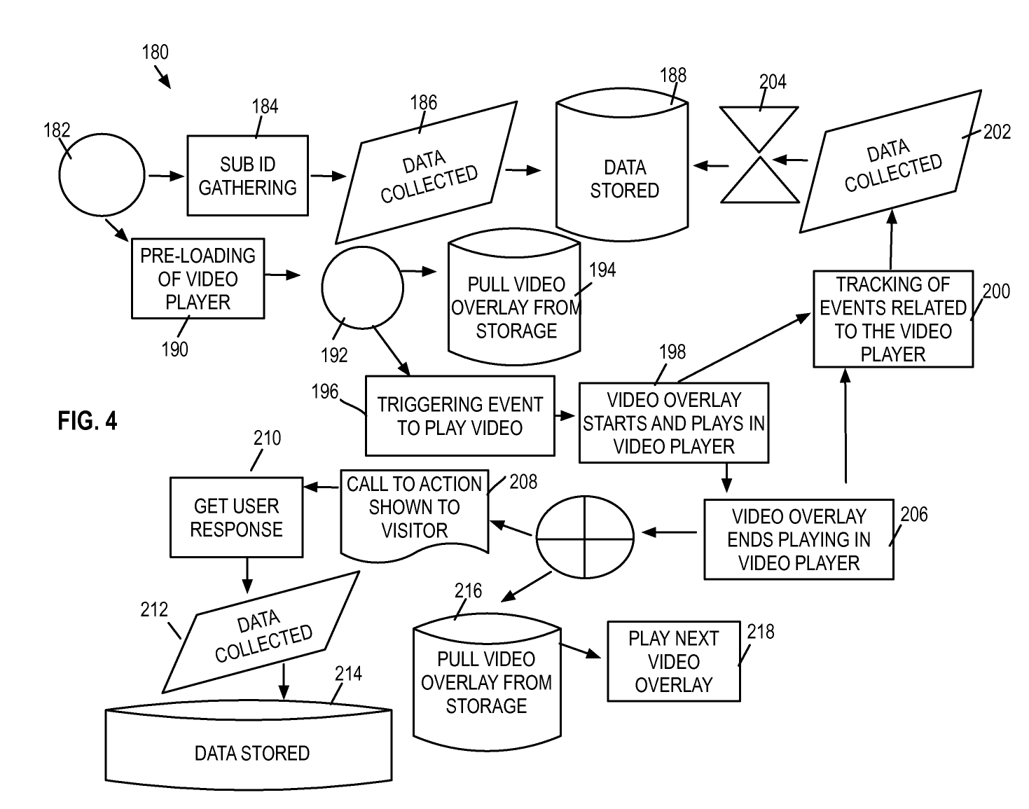

FIG. 4 is a process flow diagram 180 for one implementation illustrating the stages involved in creating and playing video overlays with a customizable video player, and collecting usage data regarding the video overlays. It will be appreciated that while stage numbers are used to refer to the different aspects of FIG. 4 and that an example ordering is shown for one implementation, no particular order is intended to be conveyed as a requirement. In other implementations, some of the stages and interactions between components could happen one or more times and in a different order and/or with some steps being omitted. A visitor accesses a web page using a web browser (stage 182), which triggers sub-id information to be gathered (stage 184) and pre-loading of the customizable video player to occur (stage 190). As the sub-id data is collected (stage 186), the data is stored in a data store (stage 188).

For the pre-loading of the video player, the video and additional information are retrieved from storage and used to create the video overlay (stage 194). When the triggering event occurs to indicate that the video overlay should start playing (stage 196), the video overlay starts and plays in the video player on top of the web page (stage 198). Events are tracked related to the video player (stage 200), such as to track when the visitor stops playing the video overlay, takes a certain action, etc. As that data is collected (stage 202), it is collated (stage 204) and stored in the data store (stage 188).

When the video overlay ends playing in the video player, or while the video overlay is still playing (stage 206), any calls to action that have been setup for the video overlay are shown to the visitor at the appropriate time (stage 208). The response or other selection that the user makes based upon the call to action is received (stage 210), and that data is collected (stage 212) and stored (stage 214). In one implementation, based upon the response that is received from the visitor to the first call to action, another video and additional information are retrieved from storage and used to create a second video overlay. The second video overlay can then be displayed on the same or a separate web page as the first one. In other words, video overlays can be chained together, and various criteria can be specified for when one video overlay should be displayed versus another. For example, a later video overlay can be displayed whenever a certain response to a call to action is made on an earlier video overlay. This could be when a user has completed an opt-in form in a video overlay, completed a survey with a certain answer, etc. The chaining of video overlays provides numerous possibilities for customizing the video overlays that are displayed to the visitor, and allows each visitor to have an experience that has been customized for them based upon their actions.

The web site owner or other authorized users can utilize the data collected in data store (stages 188 and 214) through reports, data extracts, and/or other data analysis means, and for various purposes such as to enhance his/her marketing efforts. In one implementation, a reporting utility is provided (such as part of user admin panel 164 on FIG. 3) for accessing the data store to retrieve and analyze this usage information. As one non-limiting example, if the data shows that a certain style of video overlay performed better than another style of video overlay, the web site owner may decide to use more of the better-performing style in other areas of the site. As another non-limiting example, the data can be used to further personalize the types of videos that are presented to visitors so that they get a video that is unique to what they are seeking. There are numerous other ways that the data that is collected can be used to further enhance the marketing or other efforts of the business or businesses being represented on the web site.

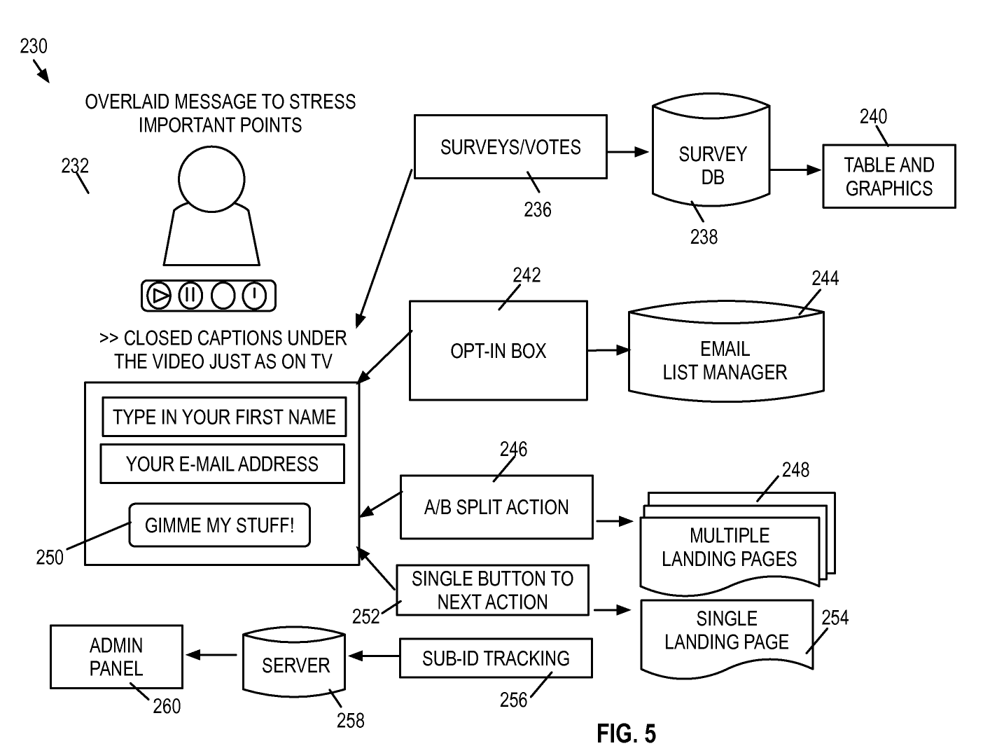

FIG. 5 is a diagrammatic view of a video overlay 230 that can be customized with a variety of call to actions. A video 232 is displayed as part of the video overlay 230, and at some point either before, during, or after the video plays, one or more calls to action can be displayed as part of the video overlay 230. In the example shown, the call to action 250 is an opt-in box. There are various types of calls to action that can be used, such as surveys/votes 236, an opt-in box 242, a split test 246 (such as an a/b split action), single button to next action 252, to name a few non-limiting examples.

When surveys/votes 236 are used as a call to action, a survey database 238 can be used to store the results and/or questions, as well as any tables or graphics 240, when applicable. When an opt-in box 242 is used (like with the present example call to action 250), an integrated or third party email list manager 244 can be used so that the information can be added to one or more suitable follow-up sequences. When a split test 246 (such as an a/b split action) is used as the call to action, the visitor can be re-directed to a different landing page 248 (i.e. web page) depending on how they answered the questions. As another non-limiting example, a different video could be displayed on the subsequent page based upon how the visitor responded to the split test. Another call to action could be a single button to a next action 252, which just means that there is a single landing page 254 (i.e. web page) that the user will be taken to upon selecting that action.

Sub-id tracking 256 is used to collect data about how the visitor reached the web site and/or the actions they take while on the site. This data is transmitted to a server 258 and can be used by the user admin panel 260 for customizing the user's experience and/or for historical data reporting purposes.

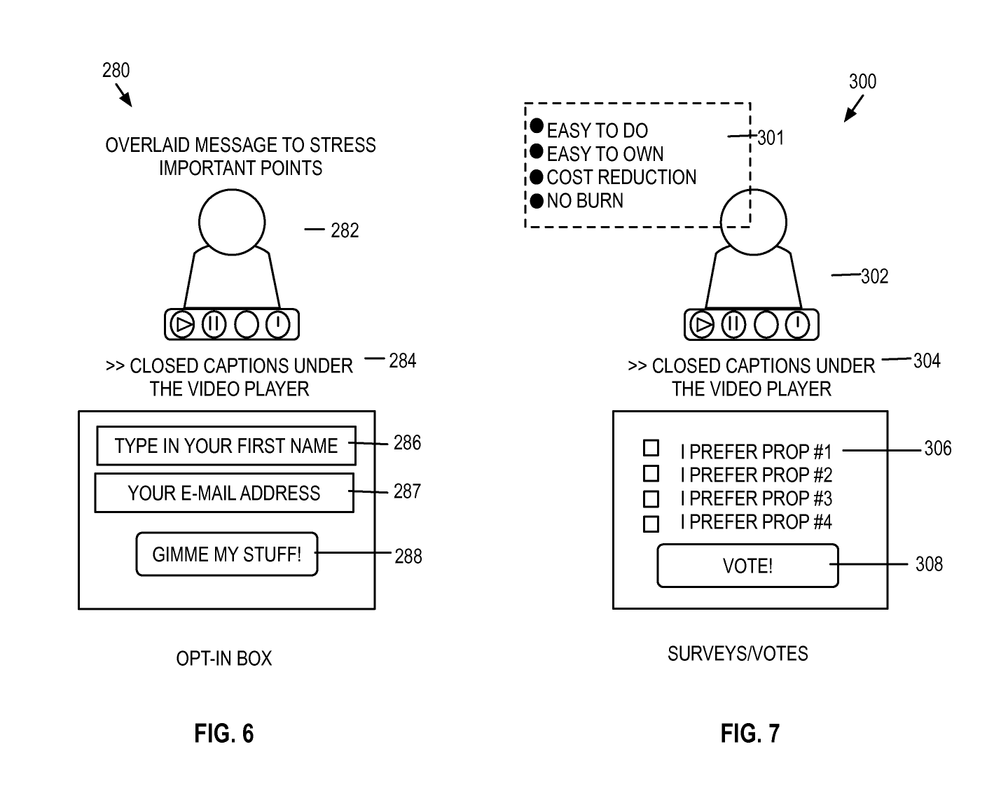

FIGS. 6-11 give several examples of video overlays that have different types of calls to action. It will be appreciated that while various customizations are shown in these examples, they are just illustrations. Numerous other combinations could be used with calls to actions and other information that is displayed on these video overlays. Other implementations may have fewer, additional, and/or different features and/or calls to action than shown in these examples. As one non-limiting example, while these examples show closed captions underneath each video, there may be video overlays that do not include closed captions. As another non-limiting example, there may be video overlays that do not use formatted lists. As yet another non-limiting example, there may be video overlays that do not use any of these calls to action, but use a totally different call to action, or no call to action at all.

Turning now to FIG. 6, a simulated screen 280 for one implementation is shown that illustrates a video overlay with an opt-in box as a call to action. In the example shown, the video overlay contains a video 282, closed captions 284, and an opt-in box that requests a first name 286, email address 287, and has a button 288 that can be clicked to submit the form. Other types of fields could be displayed on the opt-in box in other implementations, such as just an email address, a last name, etc. Once the visitor enters the first name 286 and email 287, and clicks the button 288 to submit the information, the visitor can be taken to a different web page, such as one that displays another video overlay that confirms their request for information. In another implementation, another video overlay could be displayed on the same web page that the user is already on to confirm the visitor's request for information or give other information that is relevant to their request.

FIG. 7 is a simulated screen 300 for one implementation that illustrates a video overlay with a survey as a call to action. In this example, a formatted list 301 is also displayed as a bulleted list. Formatted list 301 is displayed above video 302, and closed captions 304 are shown under video 302. Other arrangements are also possible. A survey 306 is displayed to prompt the visitor to specify a one or more preferences for a product or otherwise. Once the visitor has made a selection, they can click the vote button 308 to submit that vote. And as noted before in the discussion of FIG. 6, the next page and/or video overlay that is shown to the visitor can be customized based upon the response that the visitor provided to the survey call to action. In the example shown, simulated screen 300 also illustrates the video overlay having a second overlay that contains a formatted list. In alternate implementations, the formatted list can be omitted altogether, or displayed differently.

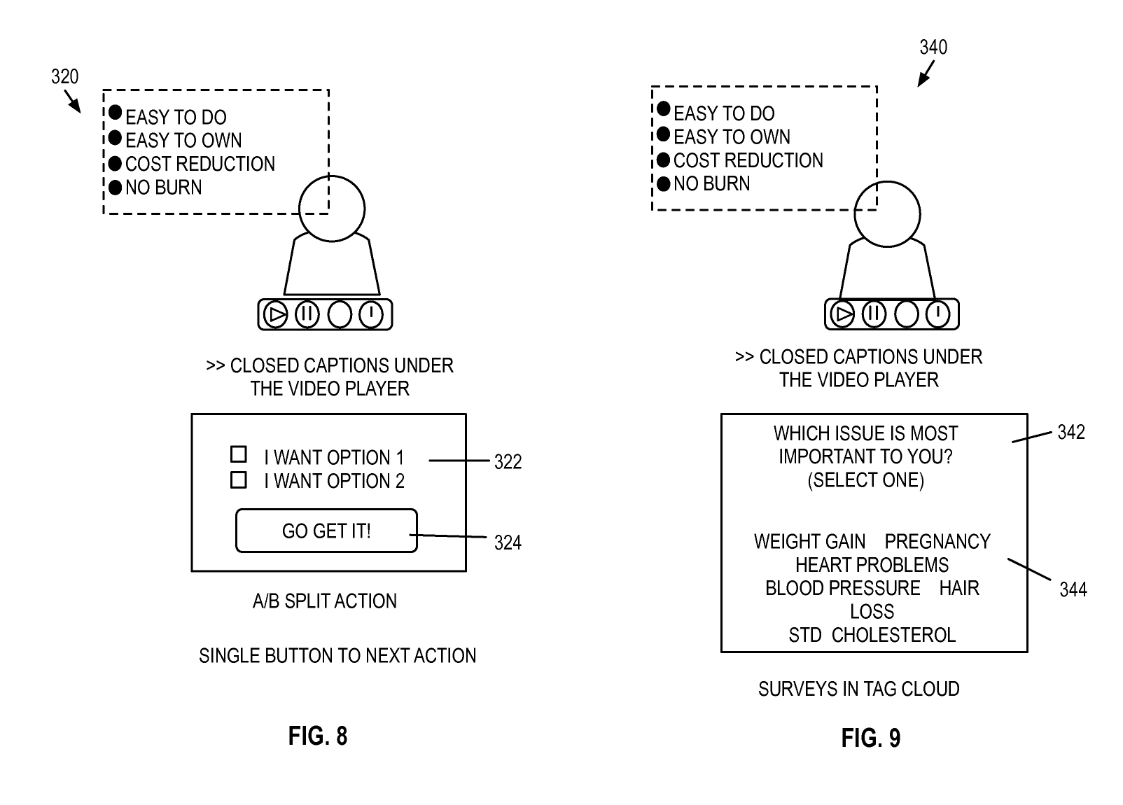

FIG. 8 is a simulated screen 320 for one implementation that illustrates a video overlay with a split test as a call to action. In the example shown, an A/B split test is used to give the visitor two different options 322. The visitor can then select the submit button 324 to submit their response, and the next video overlay and/or web page that is displayed to the visitor is tailored accordingly. In the example shown, simulated screen 320 also illustrates the video overlay having a second overlay that contains a formatted list. In alternate implementations, the formatted list can be omitted altogether, or displayed differently.

FIG. 9 is a simulated screen 340 for one implementation that illustrates a video overlay with a survey tag cloud. A prompt 342 is shown that requests the visitor to make a selection from the tag cloud 344. In one implementation, upon selecting a tag from the tag cloud 344, the visitor's response is automatically submitted, and the next video overlay and/or web page displayed accordingly. In the example shown, simulated screen 340 also illustrates the video overlay having a second overlay that contains a formatted list. In alternate implementations, the formatted list can be omitted altogether, or displayed differently.

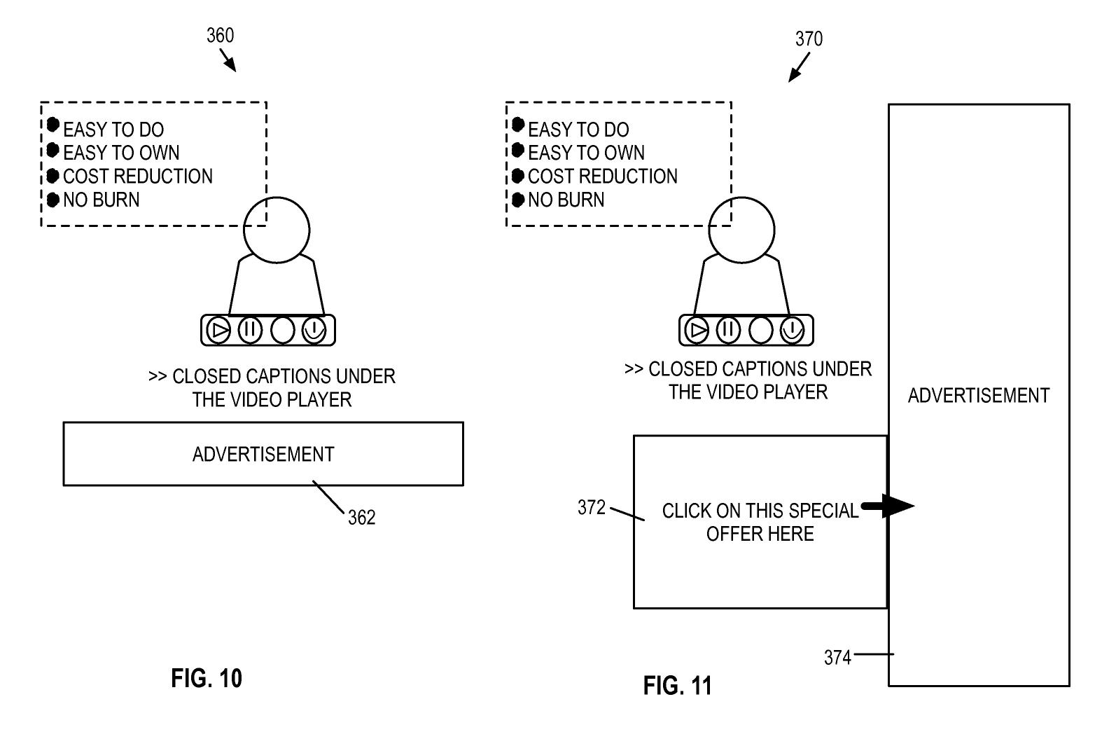

FIG. 10 is a simulated screen 360 for one implementation that illustrates a video overlay with an advertisement 362. In one implementation, when the visitor clicks on the advertisement, the visitor is taken to a page that is associated with the advertisement 362. In another implementation, a different video overlay is displayed on the same web page that the user is already on, to deliver the advertisement to them in a separate video overlay.

FIG. 11 is a simulated screen 370 for one implementation that illustrates a video overlay with an advertisement that is running on an advertising network. In this example, a customized message 372 is displayed that points to another advertisement 374. The other advertisement 374 can be any type of advertisement. In one implementation, advertisement 374 can be an advertising network offer. The term “advertising network offer” as used herein is meant to include an offer that is running on an online advertising network. A non-limiting example of such an offer could include a cost per action offer where the product owner will pay a certain amount to the advertiser (the web site owner in this example) for each instance of the desired action that is taken. In such an offer, if the desired action is to get someone to click on their advertisement, then the web site owner may be compensated by the advertising network (such as for the cost per action price for having gotten one of its visitors to take the desired action).

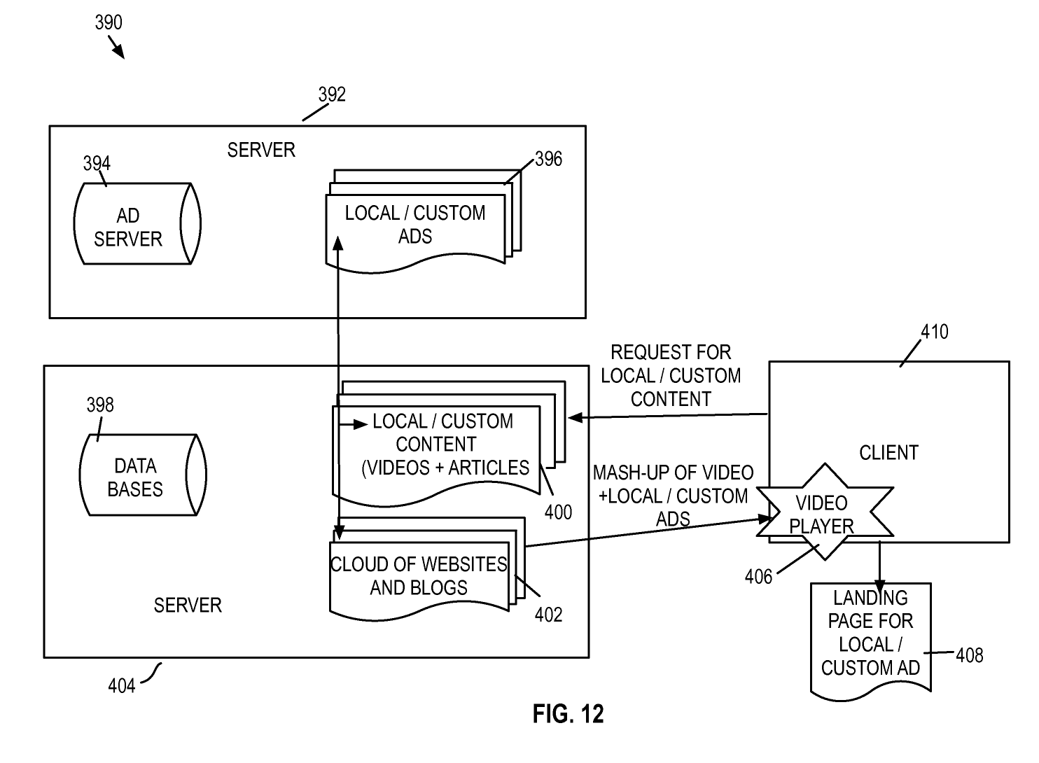

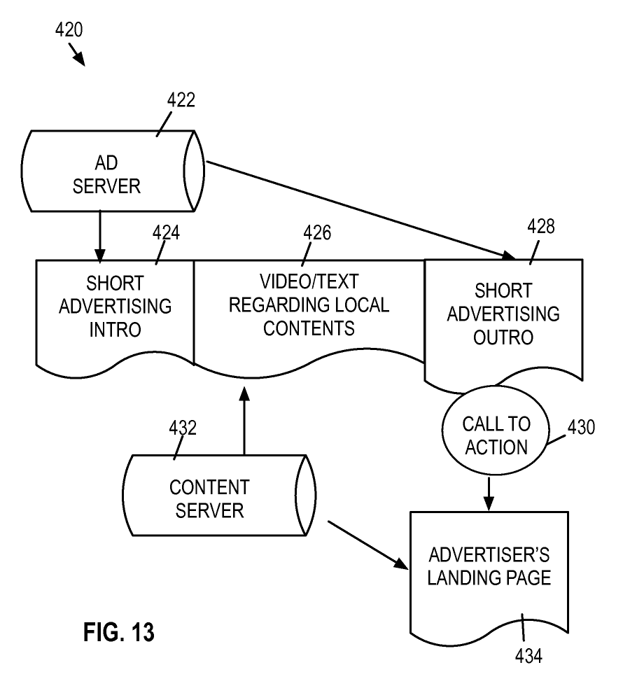

FIGS. 12-13 illustrate several ways that video overlays can be customized to deliver local content and advertising, or custom content and advertising. The video overlays can include local content or local advertising that is specific to a certain geographical location which the visitor is interested in, or the video overlays can include custom content that is selected based upon some other characteristic or action of the visitor, such as the key word the visitor used to reach the site.

Turning now to FIG. 12, a diagrammatic view 390 is shown that illustrates using a customizable video player to deliver video overlays that have local or custom content and local or custom advertising. Server 392 contains an ad server 394 and local or custom ads 396. The same or a different server 404 contains one or more data stores 398 with local or custom content 400 and web sites and blogs 402. As a visitor visits a web page using a client browser 410, the client browser 410 requests local or custom content from server 404 and/or server 392. The client browser 410 is directed to a landing page 408 (i.e. web page) that is appropriate for the scenario, and the customizable video player 406 then displays a video overlay that contains a combination of video as well as local or custom ads.

As one non-limiting example of local content, if the web site owner has pizza stores in different cities and states, a local advertisement can be displayed as part of the video overlay that directs the visitor to a coupon to the visitor's local pizza location. Using sub-id information that is gathered from the visitor, the system can tell what city and state the visitor is located in (such as from the computer's IP address). The sub-id information is then used to determine which local pizza location is closest to the user, and the advertisement that is displayed is based upon the specific location.

As another non-limiting example of custom content, if the visitor reached the web page after searching for the key word “ready to bake pizzas”, then the video overlay can be customized to include a ready to bake offer or advertisement. Alternatively or additionally, the video that is played to the visitor can be created by merging more than one video together, such as a video that has the key word pre-recorded being merged with the rest of the video. Here's a non-limiting example. Suppose short audio or video clips are recorded for the most popular key words (or are generated using text to speech). The main part of the video might say, “Welcome to our site. Thanks for requesting information about”. In this example, the partial sentence can be merged with the audio or video of the file containing the same key word that the visitor typed when they arrived to the web page. In the current example, the complete sentence would then include “Welcome to our site. Thanks for requesting information about ready to bake pizzas”.

Once the customizations are pieced together into a video overlay, the video overlay can be played for the visitor, with the unique customizations for that visitor. There are numerous other ways to customize the video overlay based upon local content, local advertisements, custom content, and/or custom advertisements. These are just a few examples that are intended to serve as illustrations.

FIG. 13 is a diagrammatic view 420 that illustrates some additional examples of what can be delivered for local or custom content and local or custom advertising with a customizable video player. FIG. 13 also illustrates possible interactions between the local content and the ad server. Various portions of video that gets included in the video overlay can be retrieved from different locations, such as a short advertising intro 424 and a short advertising outro 428 that are retrieved from ad server 422, and video/text regarding local contents 426 that are retrieved from a content server 432. A call to action 430 can also be included in the video overlay. The video overlay is created by assembling the component videos (such as 424, 468, and 428) along with any of the other customizations (such as call to action 430). The video overlay is then displayed on top of the landing page (i.e. web page).

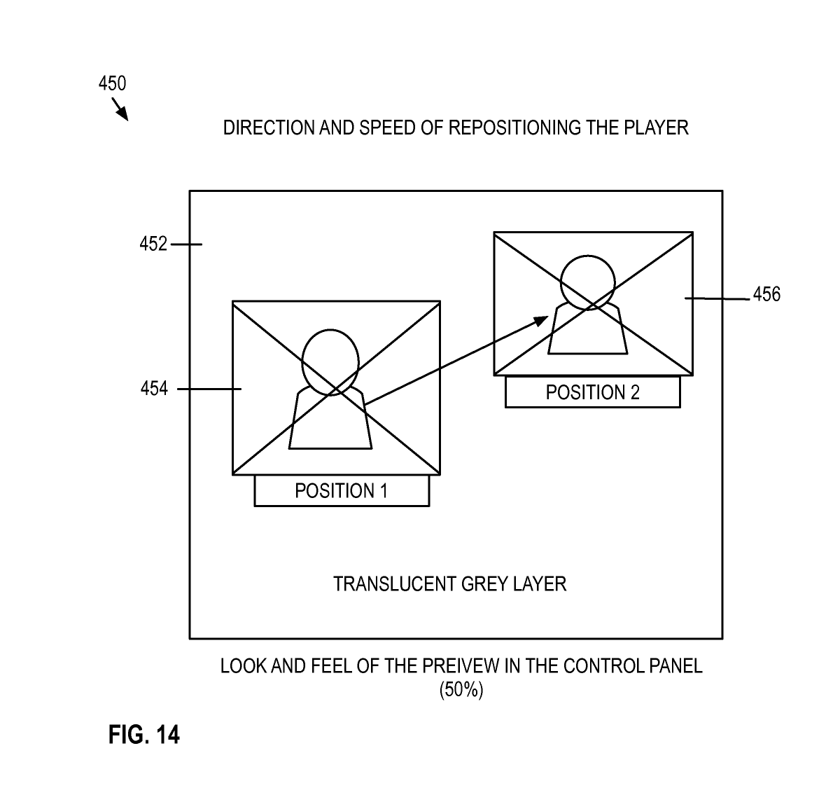

FIG. 14 is a simulated screen 450 for one implementation that illustrates repositioning the video overlay that is displayed using the customizable video player. The web site administrator or other authorized user can customize the location(s) of the video overlay for the web page. In the example shown, the video overlay starts in the first position 454 over web page 452, and then moves to the second position 456 at a later point in time. By allowing the video overlay to be positioned at multiple points on the page, different portions of the page can be demonstrated or pointed out. This can be useful for training visitors on how to find certain items on a page, or for keeping the visitor's attention by moving the video overlay around.

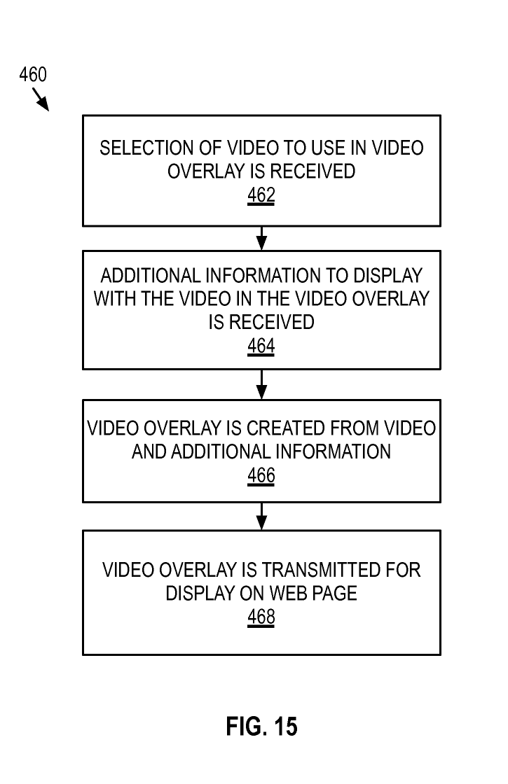

Turning now to FIGS. 15-27, several examples will be illustrated of how an administrator or other authorized user can create and manage video overlays for a web site.

FIG. 15 is a process flow diagram 460 for one implementation that illustrates creating and displaying a customizable video overlay. The administrator or other authorized user accesses the user admin panel. The administrator or other authorized user then selects a video to use as part of a video overlay that will be displayed on top of a web page in a web browser. The selection of the video is received (stage 462). Additional information to be displayed and/or used with the video as part of the video overlay is also received from the administrator or other authorized user (stage 464). This additional information can include one or more of various settings, such as closed caption, formatted list details, dimensions for the video overlay, positioning for the video overlay, call to action details, and so on. The video overlay is created from the video and the additional information (stage 466), and is transmitted for display on top of the web page when the web page is accessed by at least one visitor (stage 468). These steps will now be discussed in further detail in the simulated screens of FIGS. 16-27.

FIG. 16 is a simulated screen 490 for one implementation that illustrates some exemplary options available for creating a video overlay, and in selecting a video to use in a video overlay. In the example shown in simulated screen 490, there are eight possible customizations/steps involved in creating a video overlay. These are just examples, and in other implementations, some, all, or additional steps and/or customizations could be used. In the example shown, the user can select a video 492, select the landing pages 494 (i.e. web pages) that the video overlay should appear on, select the dimensions 496 for the video overlay and/or video itself that plays in the video overlay, create closed captions 498, create a formatted list 500 (such as with bullet points), create a call to action 502, select positions 504, and preview the video overlay 506.

Since select a video 492 is chosen as the current option, the various options for allowing the administrator to select a video are displayed on the rest of the page. For example, the administrator can select a video 508 or enter a URL where the video is located 510. A video title 512 can be specified. Once video information has been specified, the video is uploaded upon selecting the upload button 514. A list of current videos is also displayed 516 in case the administrator wants to use an existing video for the current video overlay that is being created.

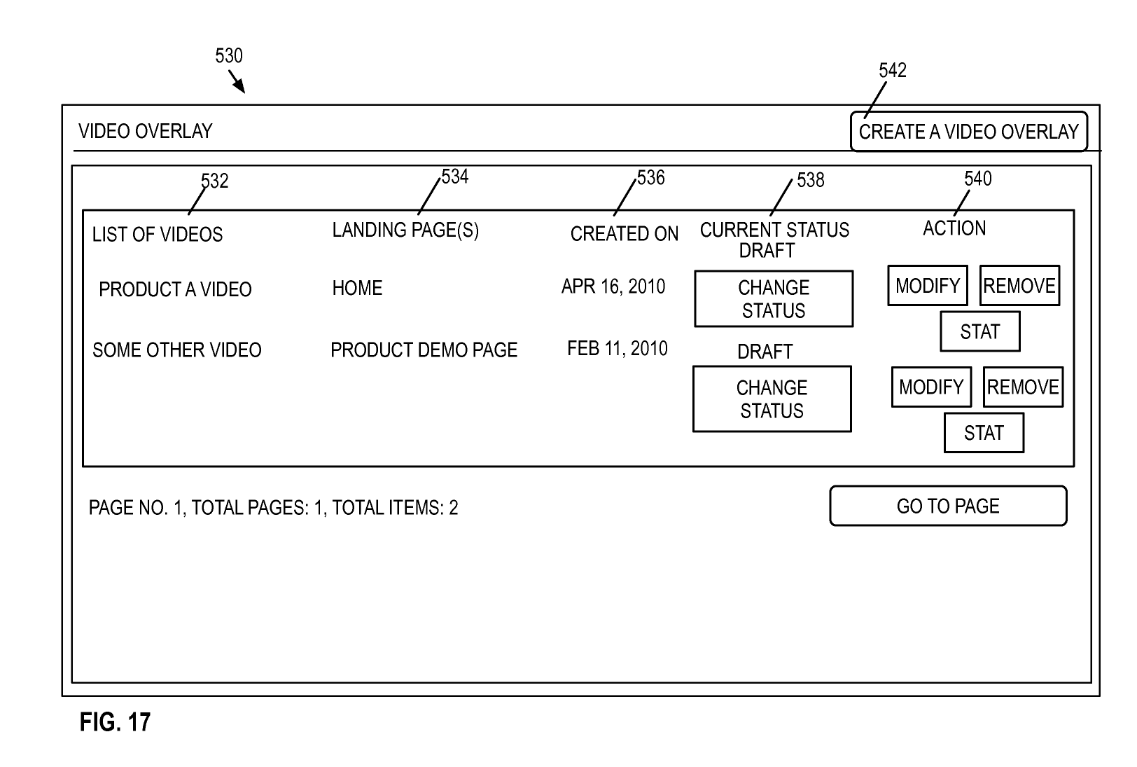

FIG. 17 is a simulated screen 530 for one implementation that illustrates viewing and modifying video overlays. A list of existing video overlays 532 is shown, along with the landing pages (i.e. web pages) that they are associated with 534, the date created 536, the current status 538 of the video overlay, and the editing actions 540 that can be taken on the video overlay.

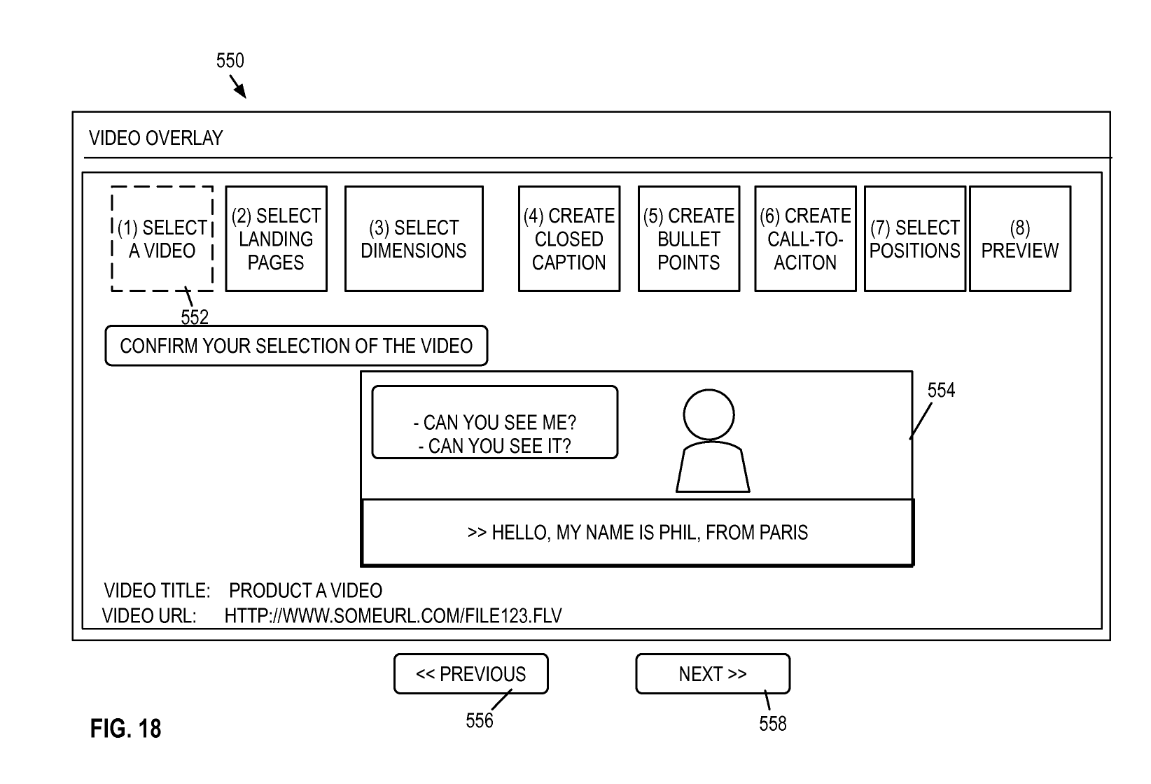

FIG. 18 is a simulated screen 550 for one implementation that illustrates confirming a video that has been selected for use in a video overlay. As part of the select a video step 552, the administrator is prompted to specify the video that has been selected for inclusion in the video overlay. The currently selected video 554 is displayed. The administrator can select the next button 558 to confirm that video selection, or the previous button 556 to select a different video.

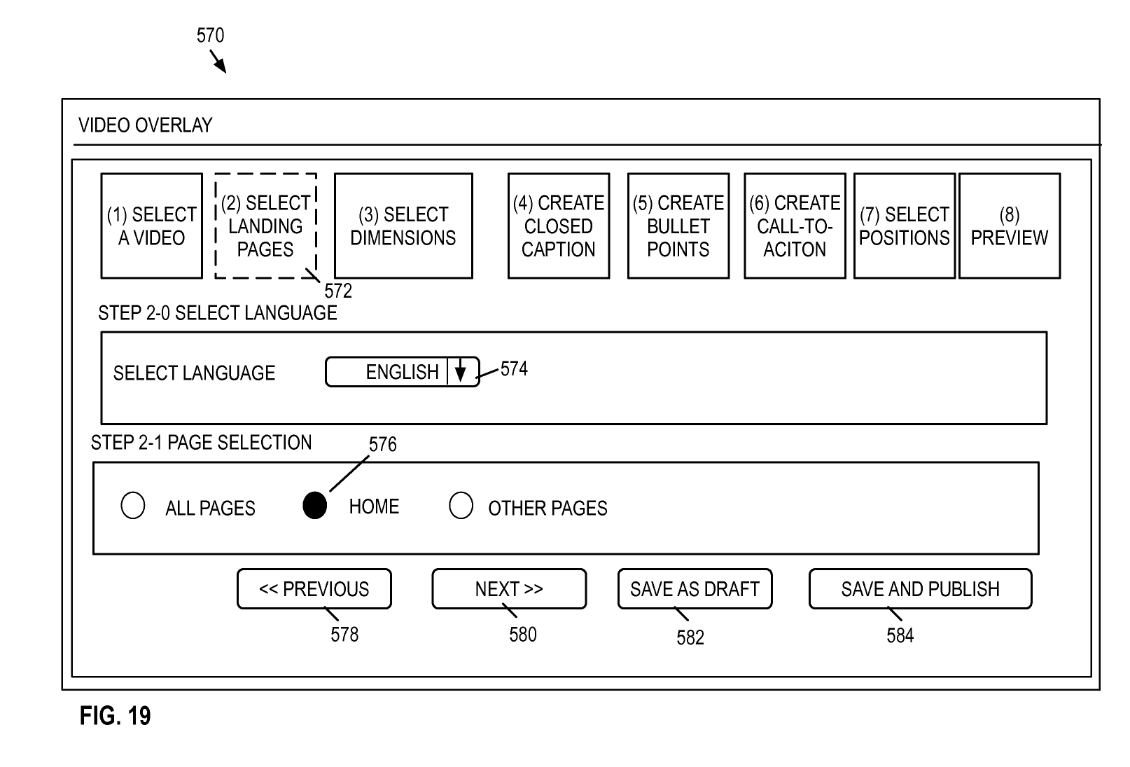

FIG. 19 is a simulated screen 570 for one implementation that illustrates selecting one or more web pages to display the video overlay on top of. In one implementation, a language 574 can be selected for the video overlay. The web page(s) that the video overlay should appear on 576 can also be specified. To continue to the next step in the video overlay creation process, the administrator can select the next button 580. To return to a prior step, the administrator can select the previous button 578. The current video overlay can be saved as a draft by selecting the save as draft button 582, or the current video overlay can be activated on the web site by selecting save and publish button 584. In the example shown, once the video has been selected and the landing page that the video overlay should be displayed on have been selected, the video overlay can be activated on the web page without specifying any of the other options that are available. However, the administrator can also take advantage of the other features when desired or appropriate for the circumstances.

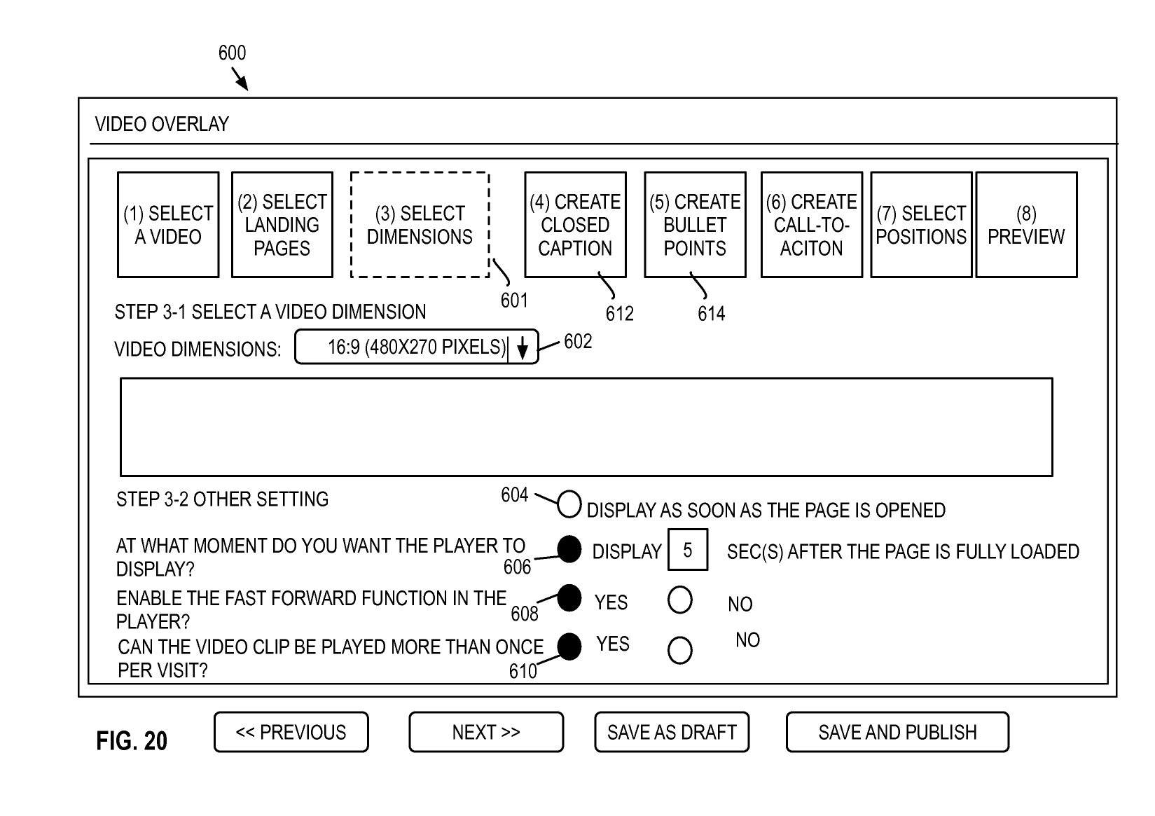

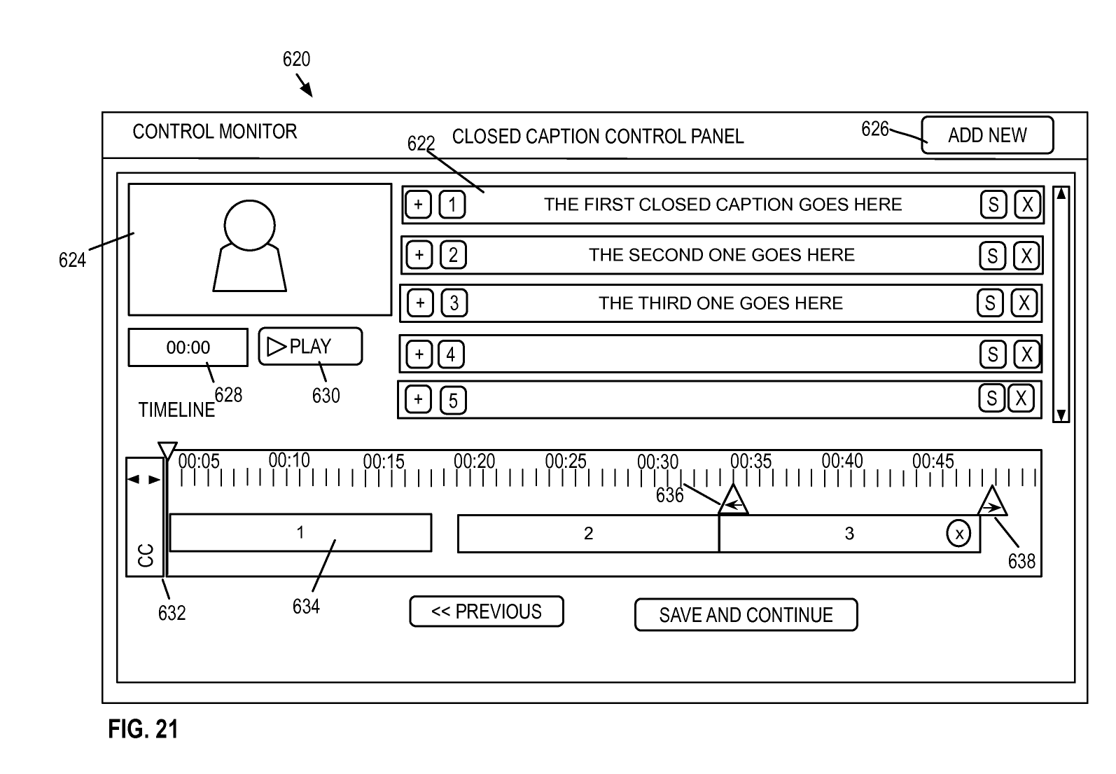

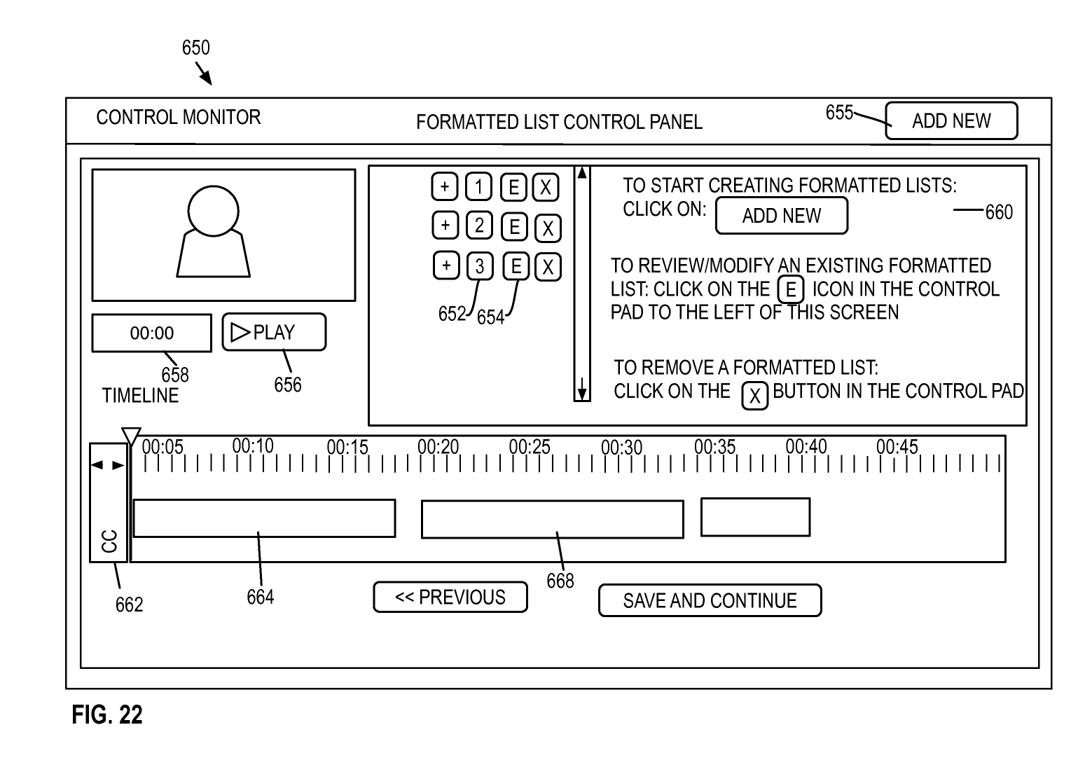

FIG. 20 is a simulated screen 600 for one implementation that illustrates selecting dimensions to be used for the video overlay. In the example shown, the dimensions 602 that the video should be displayed in can be selected, as well as other settings for when the video should play. For example, options are available for having the video play as soon as the page is opened 604 or a certain number of seconds after the page is fully loaded 606. Options are available for specifying whether to allow the fast forward function 608 to be displayed in the player, and whether to allow the video overlay to be played more than one time per visit 610. Upon selecting the create closed caption option 612, a screen similar to FIG. 21 is then displayed to allow closed captions to be created. Upon selecting the create formatted list option 614, a screen similar to FIG. 22 is then displayed to allow formatted lists to be created.

FIG. 21 is a simulated screen 620 for one implementation that illustrates adding closed caption information to be displayed with the video 624 in the video overlay. A new closed caption can be created by selecting the add new button 626. The text 622 for the closed captions can be edited. A timeline 632 allows the administrator to specify when each closed caption should appear at specific points in time of the video 624. For example, the first closed caption 622 will be displayed according to the first time range 634. A starting point adjuster 636 allows a start point to be set for a given closed caption, and an ending point adjuster 638 allows an end point to be set for a given closed caption. The user can customize the timeline 632 so that the closed captions will appear at the desired points in time when the video 624 plays. A video timer 628 is shown to aid in this process, and a play button 630 allows the video 624 to be played so the closed captions can be assigned and refined. In one implementation, upon pressing the play button 630, the current closed captions that have been assigned can be previewed with the video 624.

FIG. 22 is a simulated screen 650 for one implementation that illustrates adding a formatted list to be displayed in the video overlay. A new formatted list can be created upon selecting the add new button 655. To modify an existing formatted list 652, the edit option 654 can be selected for the desired formatted list 652. Upon selecting the play button 656, the video can be played so the formatted list contents can be assigned and refined. In one implementation, upon pressing the play button 656, the current formatted list contents that have been assigned can be previewed with the video. A video timer 658 is also displayed so the timing of the video can be viewed. Additional instructions 660 are displayed to explain how to create and manage formatted lists. And a timeline 662 allows the administrator to customize when the formatted list contents will be played. In the example shown, the first formatted list entry 664 will be displayed at one point in the timeline, and the second formatted list entry 668 will be displayed at a later point in the timeline. The formatted list can include a variety of types of information, such as important points to make about the contents of the video overlay.

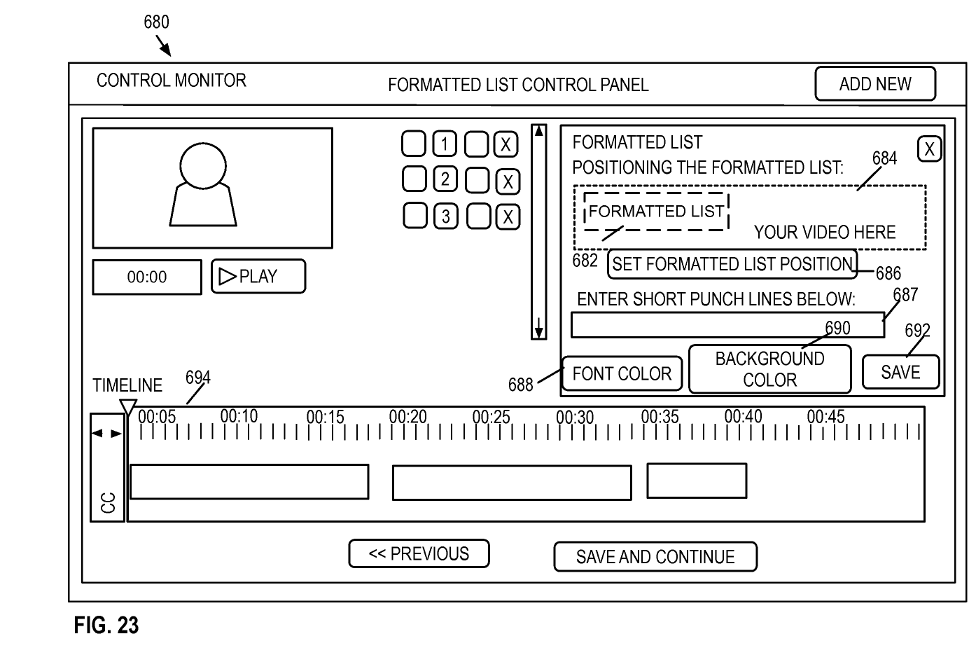

FIG. 23 is a simulated screen 680 for one implementation that illustrates customizing the position and other details for a formatted list to be displayed in the video overlay. The position 682 of the formatted list can be specified in relation to the video 684 upon selecting the set formatted list position option 686. The formatted list contents (such as text and/or images to display in the formatted list) can be entered as separate lines of content in the punch lines field 687. The font color can be adjusted for the formatted list upon selecting the font color option 688. The background color can also be adjusted for the formatted list upon selecting the background color option 690. Changes to the formatted list can be saved upon selecting the save option 692. The timing of when the formatted list is displayed can be customized using timeline 694.

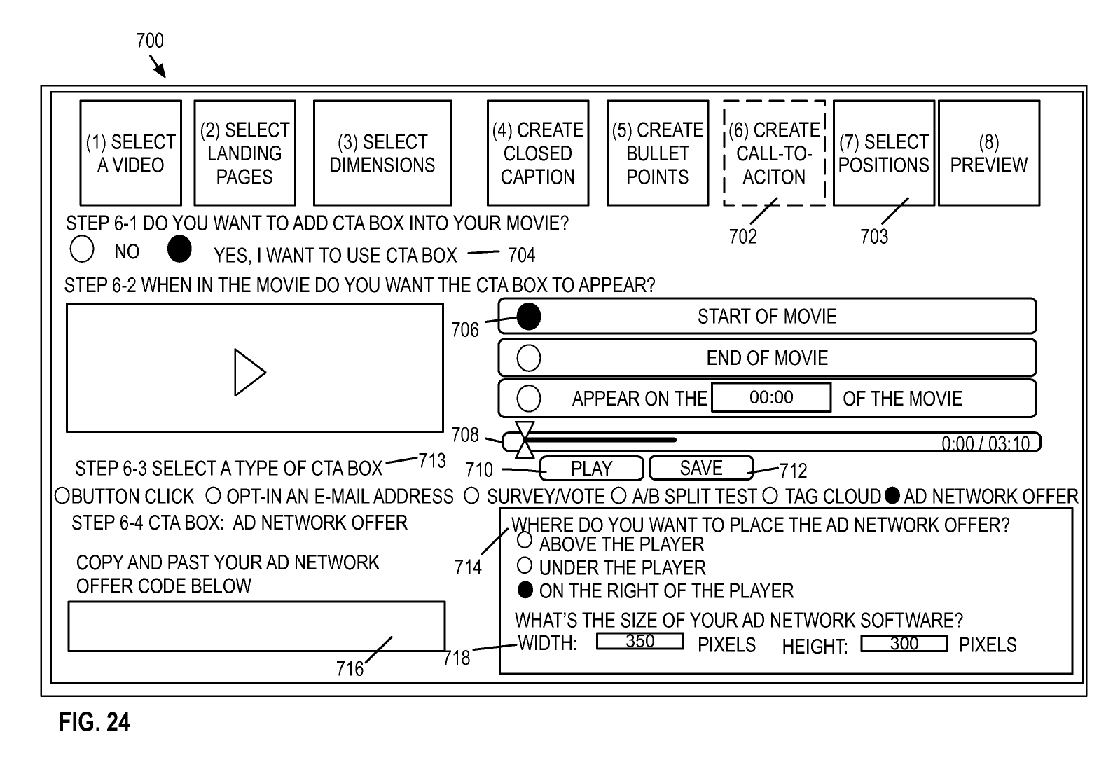

FIG. 24 is a simulated screen 700 for one implementation that illustrates creating a call to action for the video overlay. Upon selecting the create call to action option 702, the various call to action settings are displayed. The administrator can specify whether to include a call to action 704 with the video overlay. The point in time 706 when the call to action should appear in the video overlay can be set. A slider bar 708 allows the playback of the video within the control panel to be adjusted so the exact point in time that the call to action should appear can be determined. The video can be played upon pressing the play button 710. The call to action settings are saved upon selecting the save button 712.

The type 713 of call to action can also be specified, such as click on a button, opt-in box, survey/vote, split test, tag cloud, or advertising network offer. When advertising network offer is selected as the call to action, position information 714 can be specified on whether to display the advertising network offer, the size of the advertising network software 718. Code 716 for the advertising network offer can be copied and pasted for use as part of the video overlay. Some advertising networks (cost per action networks or otherwise) will provide special tracking codes that need to be included in the advertisement in order for advertisers to get credit for it properly through their tracking systems. Such special code can be included in the section called code 716 for the advertising network offer.

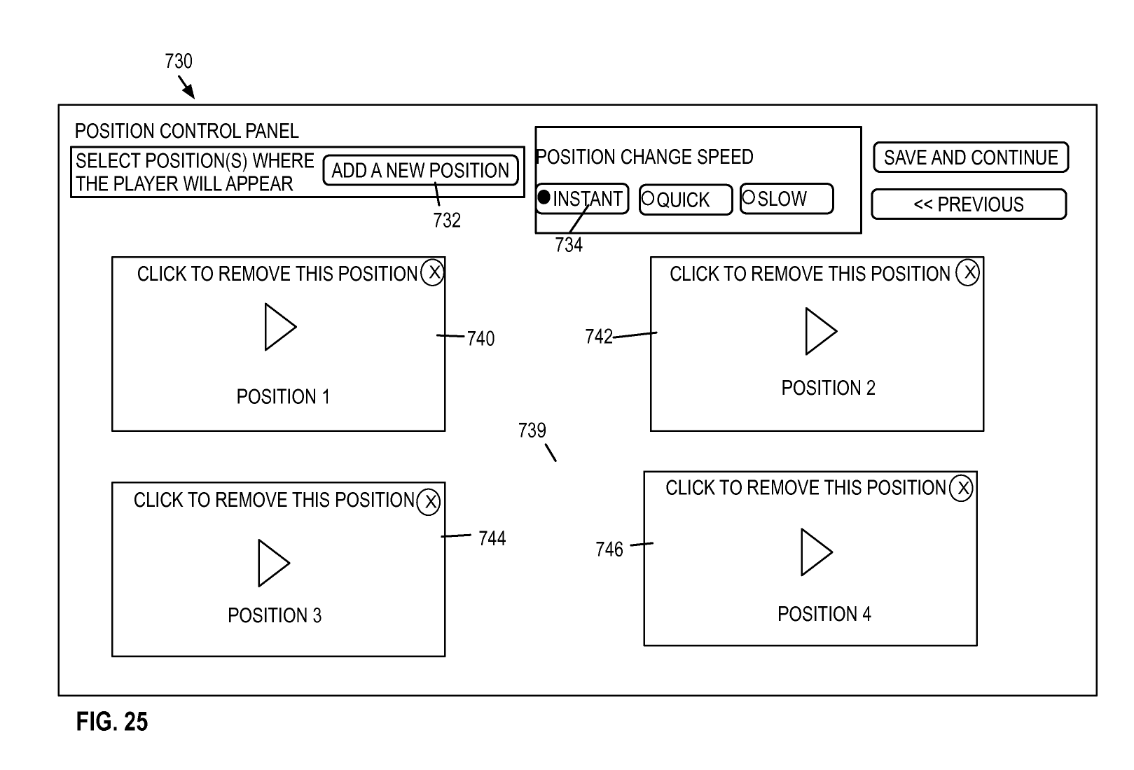

Upon selecting position option 703, a screen similar to FIG. 25 is then displayed. FIG. 25 is a simulated screen 730 for one implementation that illustrates selecting display positions for the video overlay. The video overlay can be displayed at one or more positions on the particular web page 739. A new position can be added by selecting the add new position option 732. The speed of how the video overlay moves from one position to another can also be adjusted by selecting the desired position speed option 734. In the example shown, the video overlay will be displayed in four different positions on top of web page 739, starting with the first position 740, then the second position 742, then the third position 744, and finally the fourth position 746. In other implementations, fewer or additional positions can be specified.

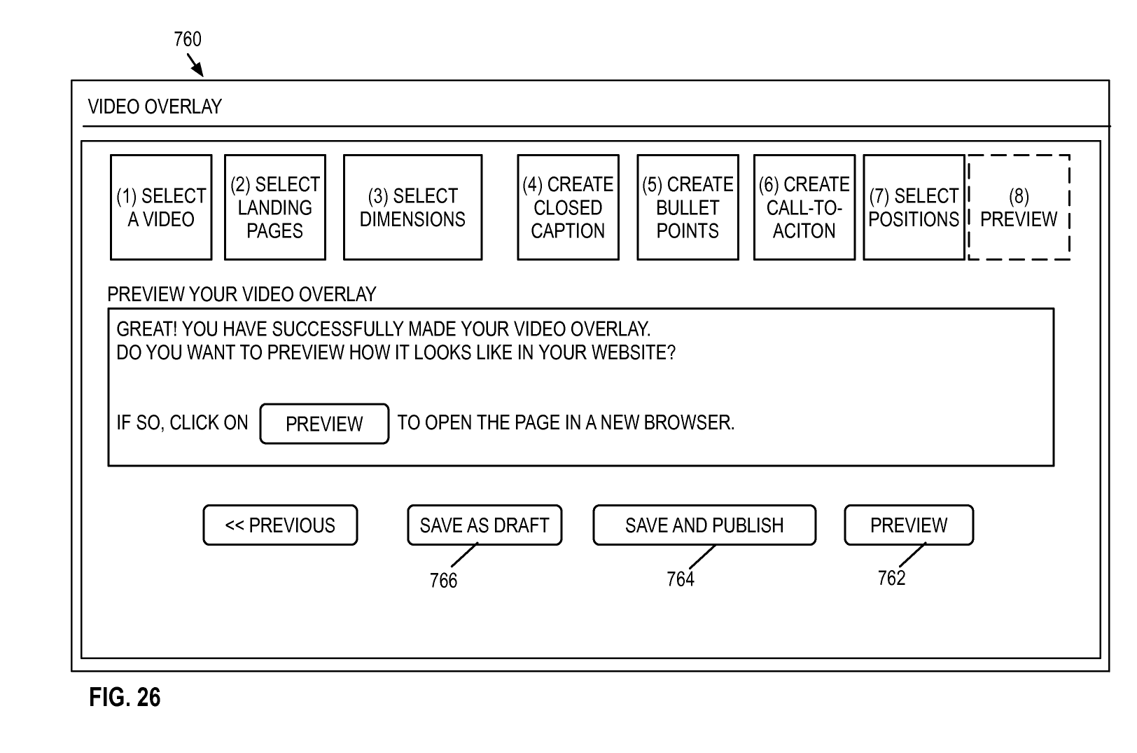

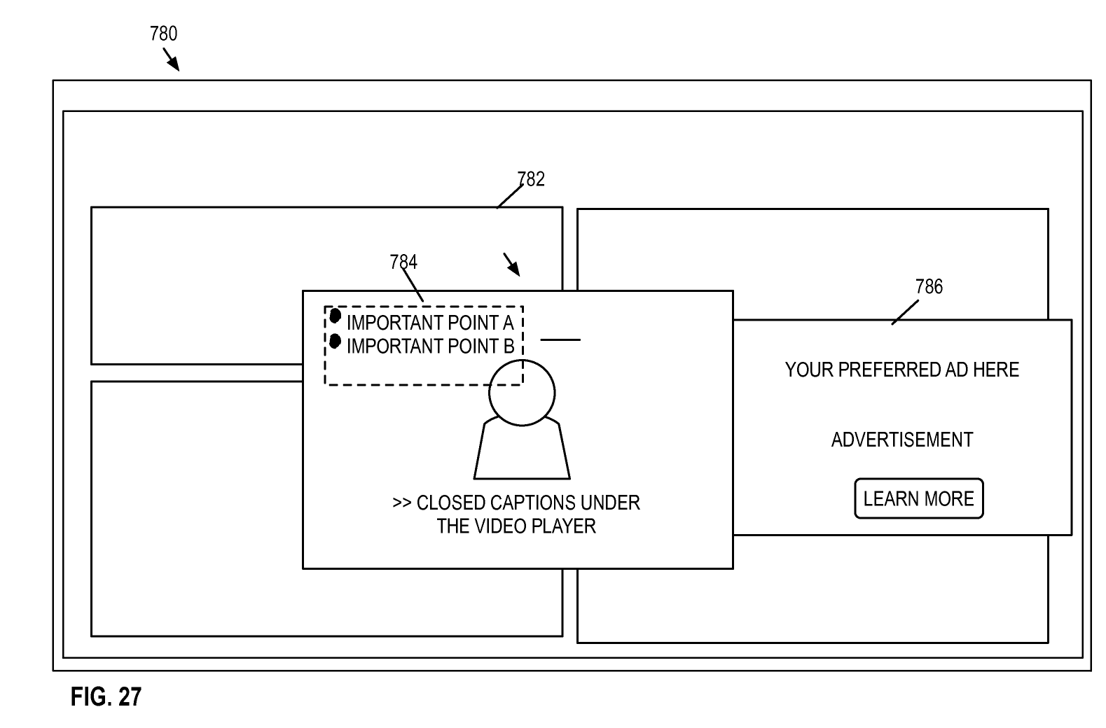

FIG. 26 is a simulated screen 760 for one implementation that illustrates the preview options that will allow the video overlay to be previewed on the web page. Upon selecting preview button 762, a preview of the video overlay will be displayed on top of the web page, such as in the example shown in FIG. 27. The video overlay can be saved and published 764 if it is finished and ready for being displayed to visitors of the web site. The video overlay can be saved as a draft 766 if it is not yet ready to be displayed to visitors on the web site.

FIG. 27 is a simulated screen 780 for one implementation that illustrates previewing the video overlay 784 on the top of the web page 782 to see how it looks. In the example shown, an advertisement 786 is also displayed as a call to action. This preview allows the administrator to preview exactly how the video overlay will be displayed to visitors of the web page, so any further adjustments can be made to the settings if desired.

As shown in FIG. 28, an exemplary computer system to use for implementing one or more parts of the system includes a computing device, such as computing device 900. In its most basic configuration, computing device 900 typically includes at least one processing unit 902 and memory 904. Depending on the exact configuration and type of computing device, memory 904 may be volatile (such as RAM), non-volatile (such as ROM, flash memory, etc.) or some combination of the two. This most basic configuration is illustrated in FIG. 28 by dashed line 906.

Additionally, device 900 may also have additional features/functionality. For example, device 900 may also include additional storage (removable and/or non-removable) including, but not limited to, magnetic or optical disks or tape. Such additional storage is illustrated in FIG. 28 by removable storage 908 and non-removable storage 910. Computer storage media includes volatile and nonvolatile, removable and non-removable media implemented in any method or technology for storage of information such as computer readable instructions, data structures, program modules or other data. Memory 904, removable storage 908 and non-removable storage 910 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 900. Any such computer storage media may be part of device 900.

Computing device 900 includes one or more communication connections 914 that allow computing device 900 to communicate with other computers/applications 915. Device 900 may also have input device(s) 912 such as keyboard, mouse, pen, voice input device, touch input device, etc. Output device(s) 911 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A video playback system comprising;
a customizable video player that enables a plurality of settings to be specified for a video overlay, the plurality of settings including a video to play as part of the video overlay as well as additional information to display with the video as part of the video overlay, the customizable video player further enabling the video overlay to be displayed on top of a web page when the web page is accessed by at least one visitor.

2. The video playback system of claim 1, wherein the additional information includes closed caption information to display as part of the video overlay.

3. The video playback system of claim 1, wherein the additional information includes a formatted list as part of the video overlay.

4. The video playback system of claim 1, wherein the additional information includes at least one call to action to display as part of the video overlay.

5. The video playback system of claim 4, wherein the call to action includes an opt-in form.

6. The video playback system of claim 4, wherein the call to action includes a survey.

7. The video playback system of claim 4, wherein the call to action includes a split test action.

8. The video playback system of claim 4, wherein the call to action includes a tag cloud survey.

9. The video playback system of claim 4, wherein the call to action includes an advertisement.

10. The video playback system of claim 4, wherein the customizable video player is further operable to display an additional video overlay based upon how the at least one visitor responds to the call to action.

11. The video playback system of claim 1, wherein the additional information includes at least one location where the video overlay should be displayed on top of the web page.

12. The video playback system of claim 1, wherein the additional information includes a plurality of locations where the video overlay should be displayed on top of the web page to illustrate different portions of the web page.

13. The video playback system of claim 1, further comprising:
a sub-id tracker that is operable to track at least one detail regarding how the at least one visitor reaches the web page, and wherein the customizable video player further customizes the video overlay based upon information gathered by the sub-id tracker.

14. The video playback system of claim 1, further comprising:
a data store for storing the plurality of settings and usage information related to how the at least one visitor interacts with the customizable video player; and
a reporting utility that enables the usage information to be retrieved and analyzed.

15. A computer-readable medium having computer-executable instructions for causing a computer to perform steps comprising:
generate a first video overlay for display on top of a first web page, the first video overlay including a call to action; and
based upon a response received from a visitor for the call to action, generate a second video overlay for display.

16. A method for creating and displaying a customizable video overlay comprising the steps of:
receiving a selection of a video to use as part of a video overlay, the video overlay to be displayed on top of a web page in a web browser;
receiving additional information to be displayed with the video as part of the video overlay;
creating the video overlay from the video and the additional information; and
transmitting the video overlay for display on top of the web page when the web page is accessed by at least one visitor.

17. The method of claim 16, wherein the additional information includes at least one position where the video overlay will be displayed on top of the web page.

18. The method of claim 16, wherein the additional information includes at least one closed caption to display as part of the video overlay.

19. The method of claim 16, wherein the additional information includes a formatted list as part of the video overlay.

20. The method of claim 16, wherein the additional information includes at least one call to action to display as part of the video overlay.
